(19) United States
(12) Patent Application Publication
(10) Pub. No.: US 2012/0024834 A1
(43) Pub. Date: Feb. 2, 2012

(54) MELTING PEN

(76) Inventor: Floyd William Kaylor, Yorba Linda, CA (US)

(21) Appl. No.: 13/021,721

(22) Filed: Feb. 5, 2011

Related U.S. Application Data
(60) Provisional application No. 61/369,569, filed on Jul. 30, 2010.

(51) Int. Cl. H05B 3/42

(52) U.S. Cl. 219/229

(57) ABSTRACT

In one embodiment, a melting pen is provided, comprising: a heating element, which is controllably connected to a power source, means for regulating the current from said power source, which reaches said heating element, so that, said heating element is capable of melting plastic sheets of predetermined thicknesses, and a protective spring surrounding said heating element.

### CROSS-REFERENCE TO RELATED APPLICATIONS

This application claims the benefit of U.S. Provisional Application No. 61/369,569, filed Jul. 30, 2010, which is hereby incorporated by reference, to the extent that it is not conflicting with the present application.

### BACKGROUND OF THE INVENTION

1. Field of the Invention

The present invention relates generally to the hand tools field and particularly to a versatile tool, which uses hot-wire technology, for opening plastic boxes and packages containing consumer products.

2. Description of the Related Art

Plastic packages, blister packages, taped boxes, zip ties and oversized, rigid clamshell packages made of hard plastic, may help to secure items for shipping and storage, and cut down on shoplifting, but they can be a nightmare for consumers. There is even a term for the frustration they cause: ‘wrap rage’. Consumers suffer thousands of injuries per year, such as cut fingers and sprained wrists, from tools used to open packages and from the packaging itself. It's not only the packaging itself that is causing this frustration but it is also what people are using to open up the packaging. Scissors and knifes are the common implements people use, thus resulting in thousands of emergency room visits per year. Furthermore, people, such as elderly or handicap individuals, with limited hand strength, may not be able to use scissors or a knife.

Attempts were made to solve the problem. X-Acto™, OpenX™, Pyranna™, and ZipIt™ are all plastic package-opening devices that are currently on the market. These tools all use blades that cut open the packaging. Hence, the consumers still face the risk of injury by cutting. Furthermore, the blades of all of these tools go dull very quickly after opening just a few of the many packages consumers may need to open in a year. In addition, some of these tools also require a strong hand, thus making their use difficult for some consumers, especially the elderly.

It is to be noted that the problems and the associated solutions presented in this section could be or could have been pursued, but they are not necessarily approaches that have been previously conceived or pursued. Therefore, unless otherwise indicated, it should not be assumed that any of the approaches presented in this section qualify as prior art merely by virtue of their presence in this section of the application.

Therefore, a new and improved device is needed to address the problems presented above, and thus, to provide the consumers with a safe, easy and expedient means for opening consumer goods packages.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment a tool is provided, which uses a heating element, such as a nichrome wire, that heats up to melt through clamshell or blister packages, taped boxes, zip ties, and other packaging means. The heating element can be activated by pressing the top of the tool and will stay heated until the top of the tool is pressed and released. Thus, an advantage is the safe opening of such packages, without the risk of injury to users. Another advantage is the almost effortless exercise through which the user can open such packages when using this tool.

In another exemplary embodiment the tool incorporates a unique twist-off tip that allows the user to change to a flashlight or blade cutter. Thus, another advantage is the versatility of this tool.

In another exemplary embodiment the tool uses a unique design that incorporates the use of batteries, voltage/amperage regulator, fan assembly, and nichrome wire, which heats up when needed, and which, for improved safety, has a retractable tip and/or a spring guard.

The above embodiments and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1a illustrates a sectional view of a melting pen configured to function as a tool for opening packaging containers, such as plastic boxes, by using hot-wire technology, according to one embodiment.

FIG. 1b illustrates the bottom view of the melting pen from FIG. 1a.

FIG. 1c illustrates a perspective view of the melting pen from FIG. 1b.

FIG. 2a illustrates a sectional view of the pen from FIG. 1a, which was adapted to function as a penlight, according to another embodiment.

FIG. 2b illustrates the bottom view of the penlight from FIG. 2a.

FIG. 2c illustrates a perspective view of the penlight from FIG. 2b.

FIG. 3a illustrates a sectional view of the pen from FIG. 1a, which was adapted to be capable of functioning as a blade cutter, according to another embodiment.

FIG. 3b illustrates the bottom view of the blade cutter from FIG. 3a.

FIG. 3c illustrates a perspective view of the blade cutter from FIG. 3b.

FIGS. 4 a-f illustrate various views of the melting pen's housing element 105, depicted in FIG. 1b, as follows: FIG. 4a is a sectional view taken along line cc-cc in FIG. 4b, which is a side view; FIG. 4d is a top view, while FIGS. 4c and 4e are left and right views, respectively; finally, FIG. 4f is a perspective view.

FIGS. 5 a-g illustrate various views of the clamshell 115 and wire assembly (117, 118 and 119) depicted in FIGS. 1 a-b, as follows: FIG. 5b is a sectional view, while FIGS. 5a and 5c are left and right views, respectively, of FIG. 5b sectional view (half clamshell and wire assembly);

FIG. 5e is a bottom view, FIG. 5g is a back view and FIGS. 5d and 5f are perspective views of same FIG. 5b half clamshell and wire assembly.

FIGS. 6 a-e illustrate various views of the blade head 320 depicted in FIGS. 3 a-b, as follows: FIG. 6a is a side view; FIG. 6b is a perspective view; FIG. 6d is a top view, while FIGS. 6c and 6e are left and right views, respectively, of the blade head from FIG. 6d.

FIGS. 7 a-c illustrate a perspective, a cross-sectional and a longitudinal sectional view, respectively, of member 114 depicted in FIGS. 1 a-b.

FIGS. 8 a-d illustrate a perspective-sectional, a side, a left (half) and a sectional view, respectively, of flashlight head 220 depicted in FIGS. 2 a-b.

FIGS. 9 a-e illustrate various views of the cartridge 106 depicted in FIG. 1a, as follows: FIGS. 9a and 9c are perspective views of the two pieces which may compose the cartridge; FIG. 9b is a side view, while FIGS. 9d and 9e are top and right views, respectively, of FIG. 9c piece.

FIGS. 10a and 10b are perspective and side views, respectively, of cap 101 depicted in FIGS. 1 a-b.

FIG. 11a is a side view of a melting pen according to another embodiment.

FIG. 11b and FIG. 11c are left and right views, respectively, of the melting pen from FIG. 11a.

FIG. 11d is a sectional view, along line A-A, of the melting pen from FIG. 11a.

FIG. 12 is a side view of the pen from FIG. 11a, which was adapted to function as a penlight, according to another embodiment.

FIGS. 13 a-d are various views of the melting pen's head 1120 depicted in FIG. 11a, as follows: FIG. 13a is left view, FIG. 13b is a side view, FIG. 13c is a right view and FIG. 13d is a top view.

FIGS. 14 a-e are various views of the melting pen's miscellaneous components and bracket 1493 assembly, as follows: FIG. 14a is a top view, FIG. 14b is a side view, FIG. 14c is a bottom view, FIG. 14d is a left view and FIG. 14e is a right view.

FIGS. 15 a-d are various views of the bracket 1493 depicted in FIG. 14b, as follows:

FIG. 15a is a side view, FIG. 15b is a top view, FIG. 15c is a left view and FIG. 15d is a cross-sectional view along line A-A in FIG. 15a.

FIGS. 16 a-e illustrate various views of the melting pen's housing element 1105, depicted in FIG. 11a, as follows: FIG. 16a is a top view, FIG. 16b is a side view, FIG. 16c is a bottom view, FIG. 16d is a left view and FIG. 16e is a right view.

FIGS. 17 a-d are various views of the melting pen's cap 1101 depicted in FIG. 11a, as follows: FIG. 17a is a back view, FIG. 17b is a right view, FIG. 17c is sectional view taken along line A-A in FIG. 17b, and FIG. 17d is a front view.

FIG. 18a and FIG. 18b are left and side views, respectively, of the spring 1116 depicted in FIG. 11a.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope of the present invention. Therefore, the scope of the present invention is defined by the accompanying claims and their equivalents.

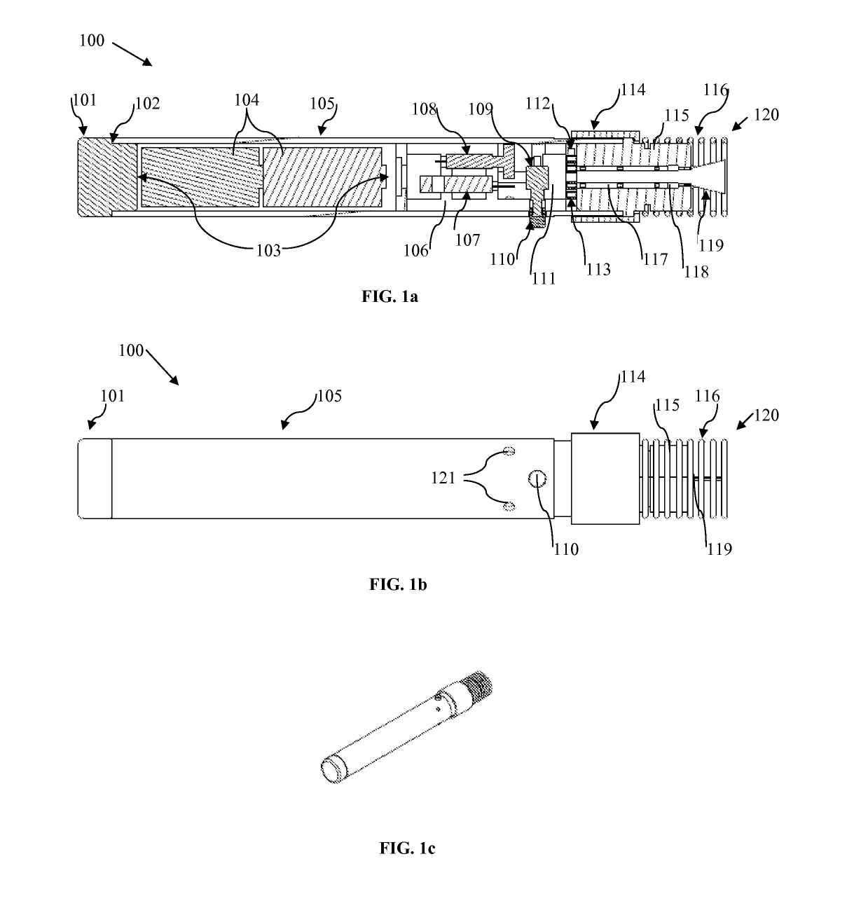

FIG. 1a illustrates a sectional view and FIG. 1b illustrates the bottom view of a melting pen 100 configured to function as a tool for opening packaging containers, such as plastic boxes, by using hot-wire technology. It is to be noted that “bottom view” is used here for facilitating the description of the respective figure(s) only. While, for example, FIG. 1a depicts the switch 109 and its cover 110 at the “bottom” of melting pen 100, it should be obvious, that, when the melting pen 100 is hand-held by the user, the switch 109 and the cover 110 will be on, and therefore, accessible from, the “top” of the melting pen 100. This would be the preferred position for easy access to the switch.

The melting pen 100 comprises three major sections: housing (or housing element) 105, head 120 and cap 101. The cap 101 is removably attached to housing 105 by using, for example, threaded coupling means. For example, on portion of the cap 101 may function as a male threaded element and a portion of the housing 105 may function as a female threaded element. Thus, a user is able to access the interior space of housing 105 and its contents, such as the batteries 104, and cartridge 106. The joint 102 between cap 101 and housing 105 may be sealed with an o-ring made of rubber, plastic or metal. Thus, the interior space of housing 105 may be protected from external agents. A portion of the exterior surface of housing 105 may have a rubber grip tape attached to it in order to help the user hold on to the tool. The housing 105 and the cap 101 may be made of aluminum or other light weight material such as plastic.

Two standard batteries 104, of 1.5 volts (V) each (i.e., 3V total), may be used to power the melting pen. This power source may be sufficient to power the melting pen 100 especially when used as a penlight as described later herein. It may also be sufficient to power the melting pen when used for opening packages (e.g., plastic packages of a predetermined thickness range) if appropriate voltage/amperage regulator 107 and/or heating wire 119 are employed. Two batteries of 1.5 V each may heat the heating wire 119 to approximately 300-400 degrees.F. However, using two batteries (e.g., lithium or nickel batteries) of approximately 3V each (i.e., approximately 6V total) may be preferred for the heating wire 119 to have a more desirable melting power. Two batteries of 3 V each may heat the heating wire 119 to approximately 600-1,000 degrees.F. It should be understood by one of ordinary skills in the art that alternative power sources may be used without departing from the scope of the invention. For example, rechargeable batteries may be used in combination with micro solar panel(s) positioned on the exterior surface of the housing 105, which may keep the batteries charged at all times.

Having batteries, or other independent power sources, powering the melting pen, represents an important advantage for the user. It makes the melting pen highly mobile, for the user to use it where he/she needs it, as opposed to a corded power supply, which makes the melting pen usable only where a nearby power outlet exists.

In the two spaces 103, standard metal coil springs (not shown) are used to provide the necessary contact between the batteries 103 and the appropriate electricity conducting members (not shown), as necessary to power the melting pen.

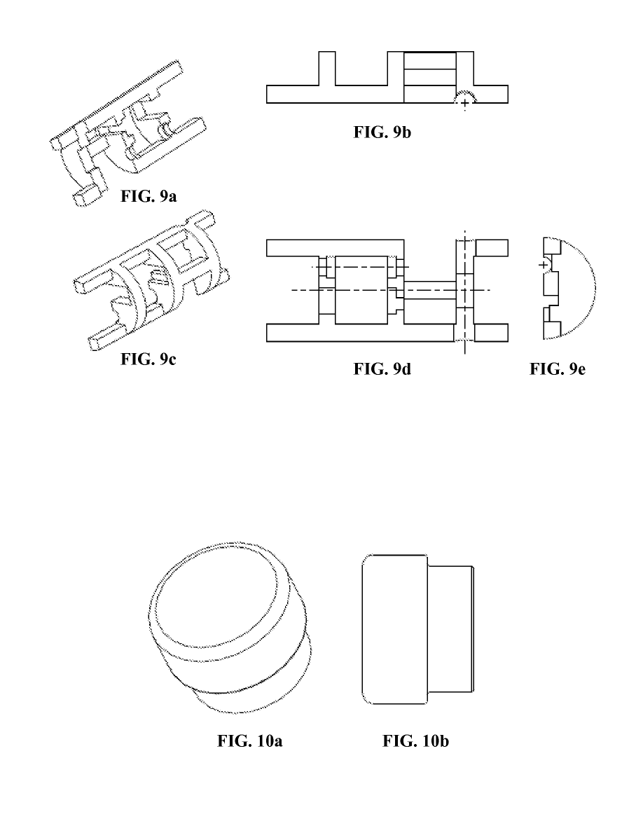

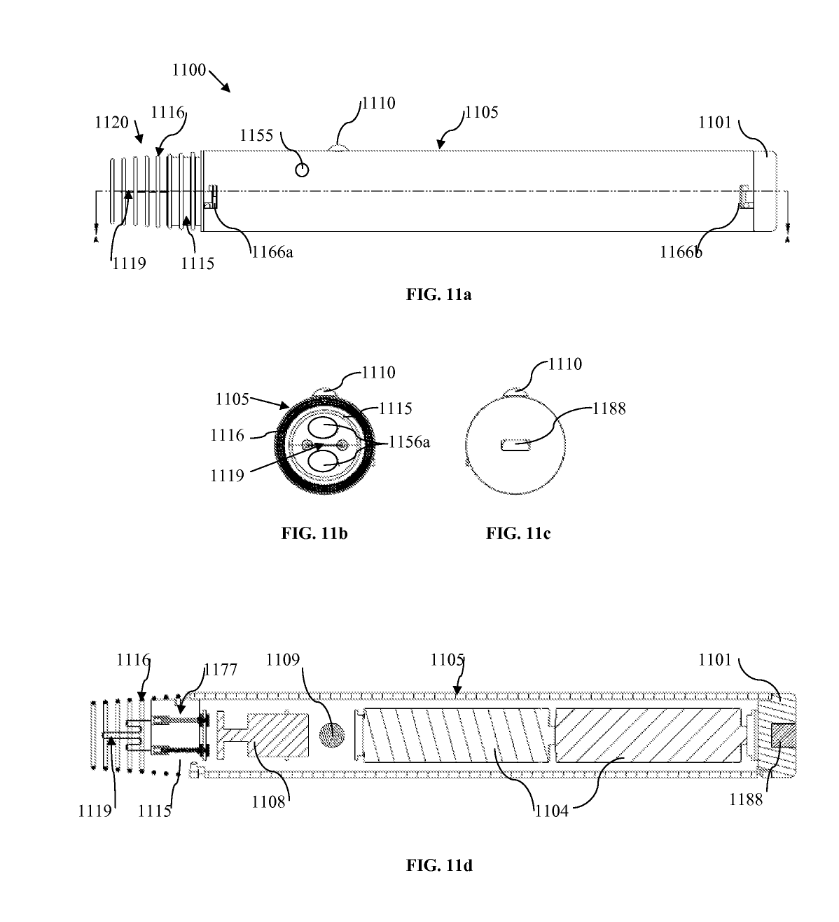

The cartridge 106 may be made of molded or machined plastic, in one piece or in two pieces (shown in FIGS. 9 a-e), and is configured to house motor and fan assembly 108, voltage/amperage regulator 107, switch 109, and filter 111. The switch 109 will be used by the user to turn on and off the heating wire 119 as well as regulator 107 and motor/fan assembly 108. This may be achieved by press-press or press-release actuation combinations exerted by the user onto the switch 109. The switch 109 may have a protective cover 110 made of materials such as rubber, plastic or aluminum.

The voltage/amperage regulator 107 may be a device, or a plurality of devices, such as a resistor, which may be configured to control or determine a first level of amperage and/or voltage of the current that reaches a first pair of contacts 113 and ultimately the heating wire 119, and a second level of current that reaches a second pair of contacts 113 and ultimately a LED light as described later herein. The first and second pair of contacts 113 may have a common neutral contact. Therefore, three of the four contacts 113 illustrated in FIG. 1a may be sufficient to power the heating wire 119 and the LED, and thus, the fourth contact, may be a spare contact, which may be used to power additional add-on or interchangeable devices. A standard metal bar 112, made of, for example, copper, may be provided to ground all the wire tips.

There is a mechanical and electrical association among the contacts 113, the insulated wire 117 and/or the heating wire 119. The insulated wire 117 may be made of copper and may have a protective exterior layer capable of thermally insulating the wire, and thus, preventing heat from being transferred to the clamshell 115, or other parts, with which it may become in contact. The thermal and mechanical connection between the insulated wire 117 and heating wire 119 may be achieved by using, for example, a metallic tube 118 in which the respective ends of the two wires are inserted and to which the two wire ends are welded.

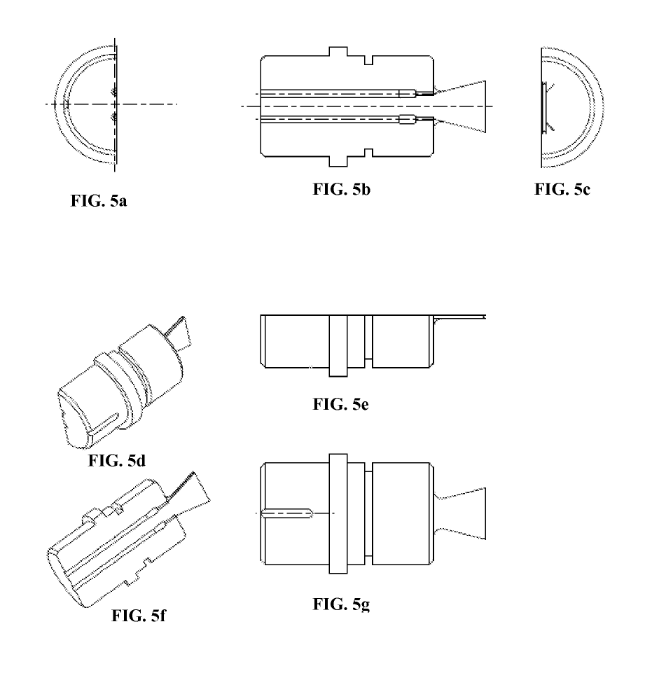

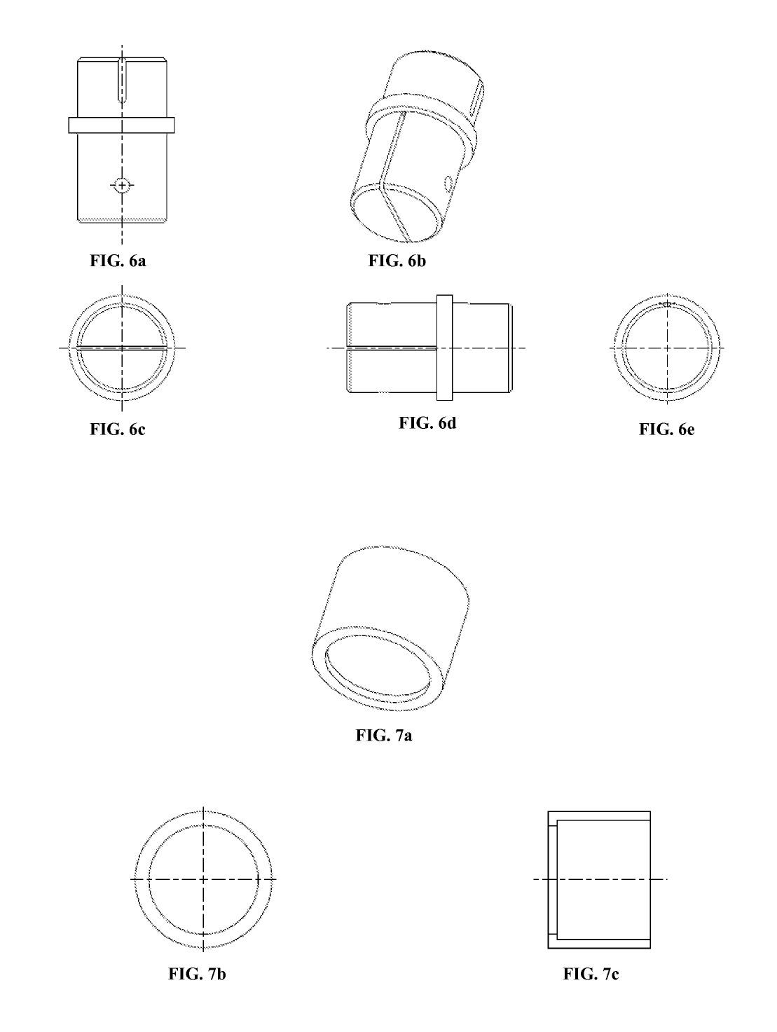

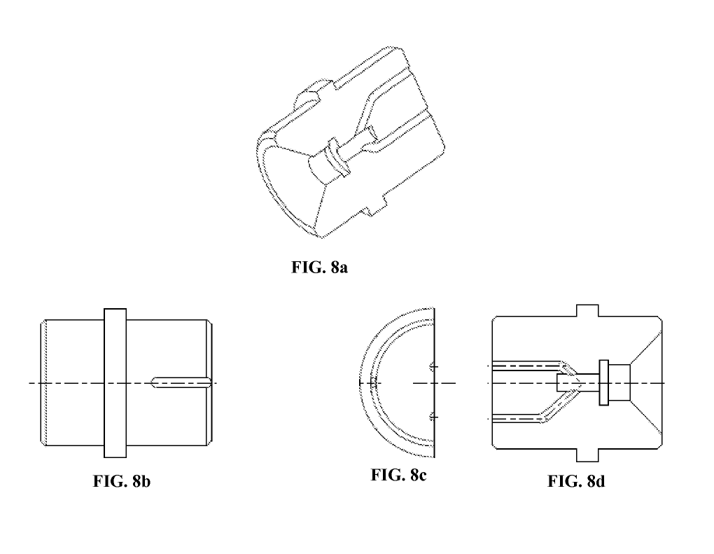

The clamshell 115 may be made of a ceramic material, to prevent or reduce heat transfer, and is configured to house a portion of the wire assembly described above (comprising the insulated wire 117, the metallic tube 118 and the heating wire 119). For easy assembling, as illustrated in FIGS. 5 a-g, the clamshell 115 may be manufactured in two pieces, which may be then glued together.

The head 120, comprising the clamshell 115, the insulated wire 117, the metallic tube 118, the heating wire 119 and the spring 116, may be removably associated with housing 105 using a metallic member as depicted in FIGS. 1a and 1b. The metallic member 114 may be made of materials such as aluminum and may engage the housing 105 using male-female threading means or other easy and fast coupling means.

The spring 116 depicted in FIGS. 1a and 1b may be a retractable metal spring and has the purpose and advantage of protecting the user of the melting pen 100 from burn injuries, which may be caused by the accidental touching of the heating wire 119, if the spring 116 would not be installed. After the melting pen 100 is turned on, by, for example, pressing switch 109, the user may simply press the head 120 against, for example, a plastic package which the user wishes to open. This will cause the spring 116 to retract, and thus, the heated wire 119 to touch and melt said plastic package, and thus opening it. Next, after the user finishes the plastic package opening and separates the melting pen 100 from said package, the spring 116 will decompress, and thus, cover, and protect against, the heated wire 119 again. Therefore, at all times, there is no lateral portion of heating wire 119 that is exposed to the user. Finally, the user has the option to turn off the melting pen 100, by, for example, pressing on the switch 109 (or its cover 110) again.

The heating wire 119 may be bent into a fishtail shape, which likely provides one of the preferred combinations between its strength, the length of its portion which is exposed to the package, and its performance. Other shapes seem to perform equally well or better, such as “W” or “M” shape. However, other shapes may be used, such as a triangular or a rectangular shape. The heating wire 119 may be made of a nichrome wire, which appears to a suitable material (i.e., nichrome) for this purpose. However, other materials with comparable properties may be used. Furthermore, one of ordinary skills in the art would recognize that the heating wire 119 may not need to be a heating element made from a wire. Other methods for manufacturing the heating element may be employed. For example, the heating element may be machined from a metal sheet or cast into a mold.

In an alternative embodiment, the exemplary fishtail, or other heating element, made from a metal sheet (or the wire after being flattened, or a molded heating element) may be sharpened, so that a combination of actions, cutting (i.e., mechanical cutting) and melting (i.e., thermal cutting), may be applied to, for example, a plastic package when its opening is desired. Such a combination of actions, simultaneously or consecutively applied, may be even more effective and still safe (by using the protective spring 116, which may be also called “spring guard”) when opening such a package.

The motor and fan assembly 108 has the role to aspirate the air-fumes mixture, resulting from melting plastic, through the filter 111 and expel the filtered air through holes 121 (FIG. 1b). The holes 121 may be four in number, each pair of two being diametrically opposite, or, any plurality of holes may be used. It may be advantageous to have all holes 121 placed on the opposite side of the accessible end of switch 109 or its cover 110. This is because, as the user is likely to hold the melting pen 100 with the switch 109 on top, the positioning of holes 121 on the bottom side may facilitate the channeling of the filtered air farther from the user, and thus, less likely to be inhaled by the user. This is important because any filter is unlikely to completely purify the air-fumes mixture. A carbon, charcoal or any other type of filter, that proves effective in capturing the fumes from melting plastic, may be used.

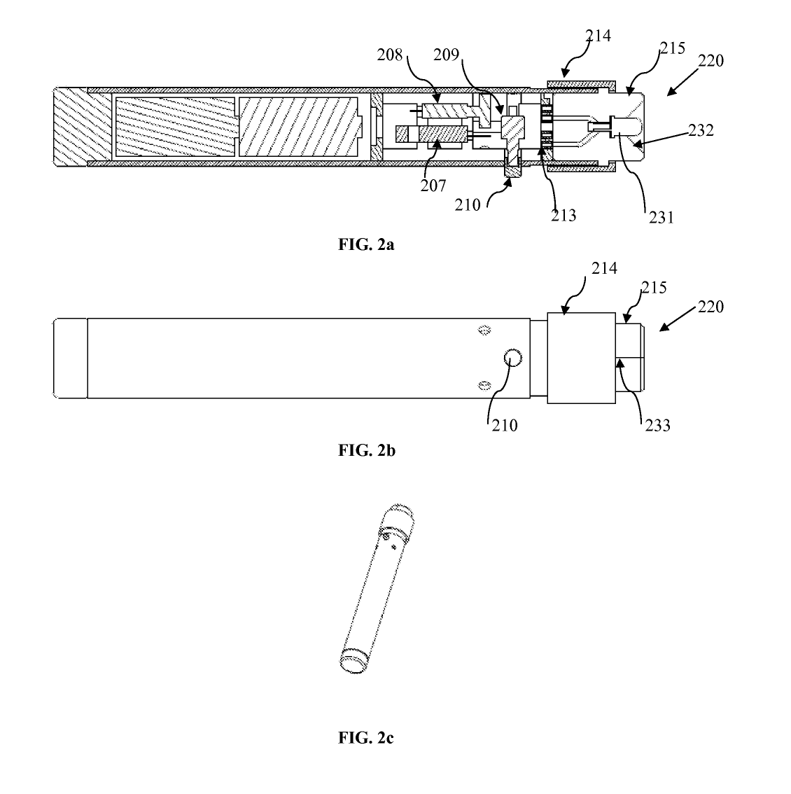

FIG. 2a illustrates a sectional view of the pen from FIG. 1a, which was adapted to function as a penlight, while FIGS. 2b and 2c illustrate the bottom view and a perspective view, respectively, of the penlight from FIG. 2a. The melting pen depicted in FIGS. 1a, 1b and 1c may be converted into a penlight by substituting its head 120 (FIGS. 1a,1b) with a flashlight head 220 (FIGS. 2a, 2b). This is a simple operation involving the decoupling and coupling of member 114 (214 in FIGS. 2a and 2b). After the flashlight head 220 is installed, the user may press the switch 209 (i.e., the end covered by switch cover 210) to turn on voltage/amperage regulator 207 and light emitter (such as an LED) 231. It is to be noted that motor-fan assembly 208 may be configured to not turn on when the pen is used as a flashlight.

The light emitter 231 is mechanically and electrically associated with a pair of contacts 213 to which regulator 207 is configured to send the appropriate current. The flashlight clamshell 215 made be made of materials such as aluminum or plastic and is configured to house the light emitter 231. For easy assembling, the flashlight clamshell 215 may be manufactured in two pieces which may be glued together along joint 233. For enhanced reflective capability, the flashlight clamshell 215 may have a mirrored concave surface 232 at its distal end, as depicted in FIG. 2a.

One of ordinary skills in the art would recognize that the head 120 and flashlight head 220 may be adapted to be mounted concomitantly to the melting pen without departing from the scope of the invention. This may be advantageous in, for example, darker spaces, by providing the user with the option of illuminating the point of melting on the package.

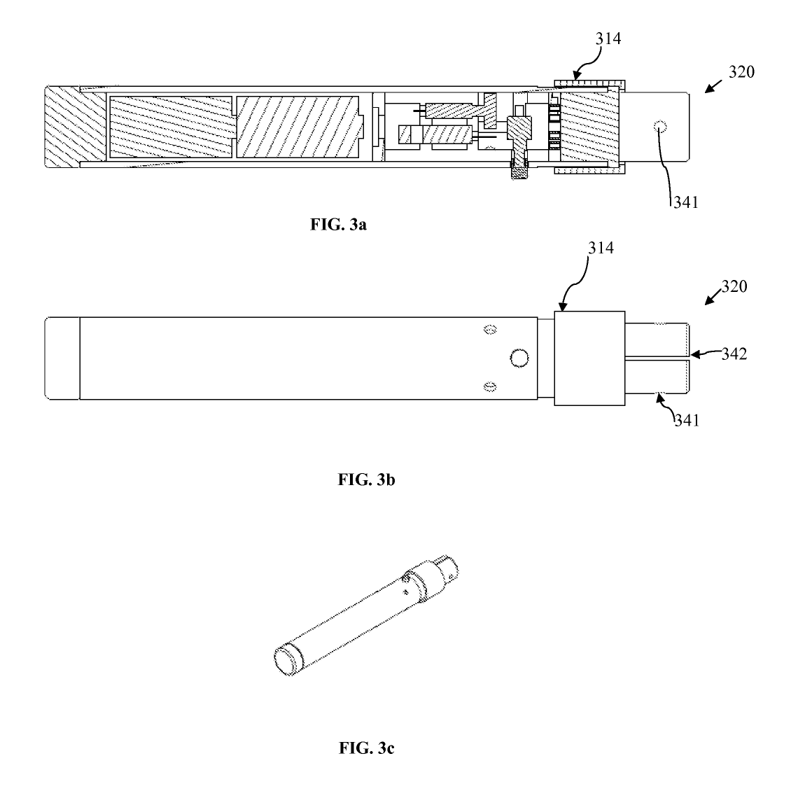

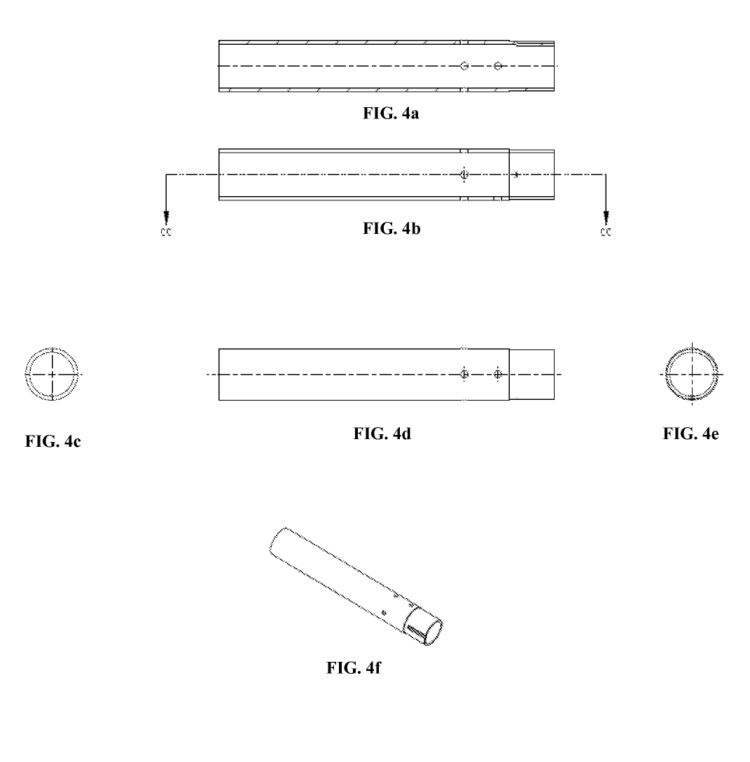

FIG. 3a illustrates a sectional view of the pen from FIG. 1a, which was adapted to function as a blade cutter, while FIGS. 3b and 3c illustrate the bottom view and a perspective view, respectively, of the blade cutter from FIG. 3a. The melting pen depicted in FIGS. 1a, 1b and 1c may be converted into a blade cutter by substituting its head 120 (FIGS. 1a,1b) with a blade head 320 (FIGS. 3a, 3b). This is a simple operation involving the decoupling and coupling of member 114 (314 in FIGS. 3a and 3b). The blade head 320 made be made of materials such as aluminum and is configured to accommodate a standard cutting blade (not shown) in gap 342. The cutting blade may be secured to the blade head 320 by inserting a screw through the threaded hole 341. The protective spring 116 depicted in FIGS. 1a and lb may be adapted to be also associated with the blade head 320 and function similarly, as earlier described, thus, providing the advantage of protecting the user from cut injuries.

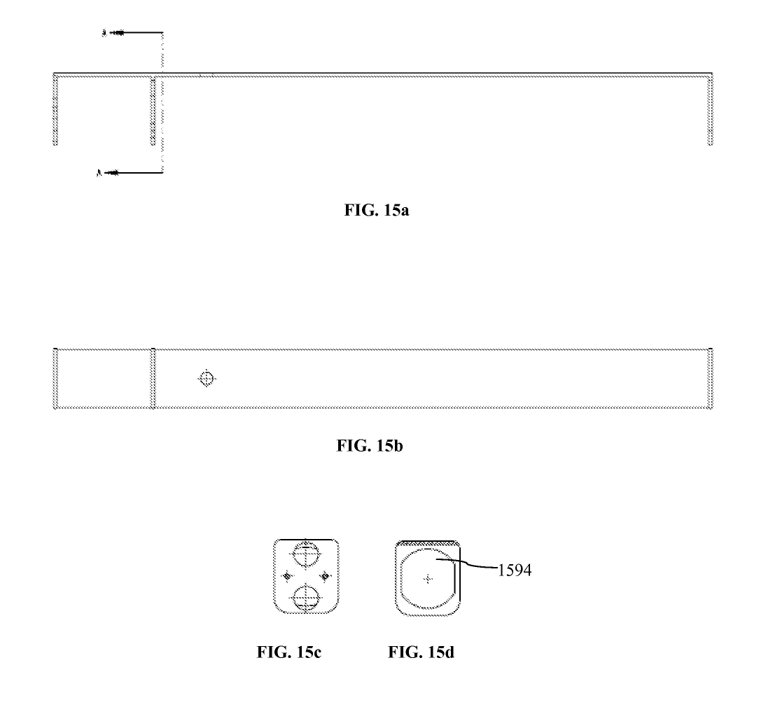

FIG. 11a is a side view of a melting pen according to another embodiment. FIG. 11b and FIG. 11c are left and right views, respectively, of the melting pen from FIG. 11a. FIG. 11d is a sectional view, along line A-A, of the melting pen from FIG. 11a. The melting pen depicted in FIGS. 11a-d is similar with the melting pen depicted in FIGS. 1a-c. However, there are several differences, some of which are major differences. The first major difference is that the voltage/amperage regulator 107 depicted in FIG. 1a is completely absent in this embodiment, as shown in FIG. 11d. An alternative wiring configuration, in which the central role is played by the bracket depicted in FIGS. 15a-d, permits reaching the objectives described above, without the need for a voltage/amperage regulator. For example, parallel or series circuit configuration(s) may be employed as necessary to correspond to the physical characteristics of the heating element (e.g., to prevent the burning of the melting element).

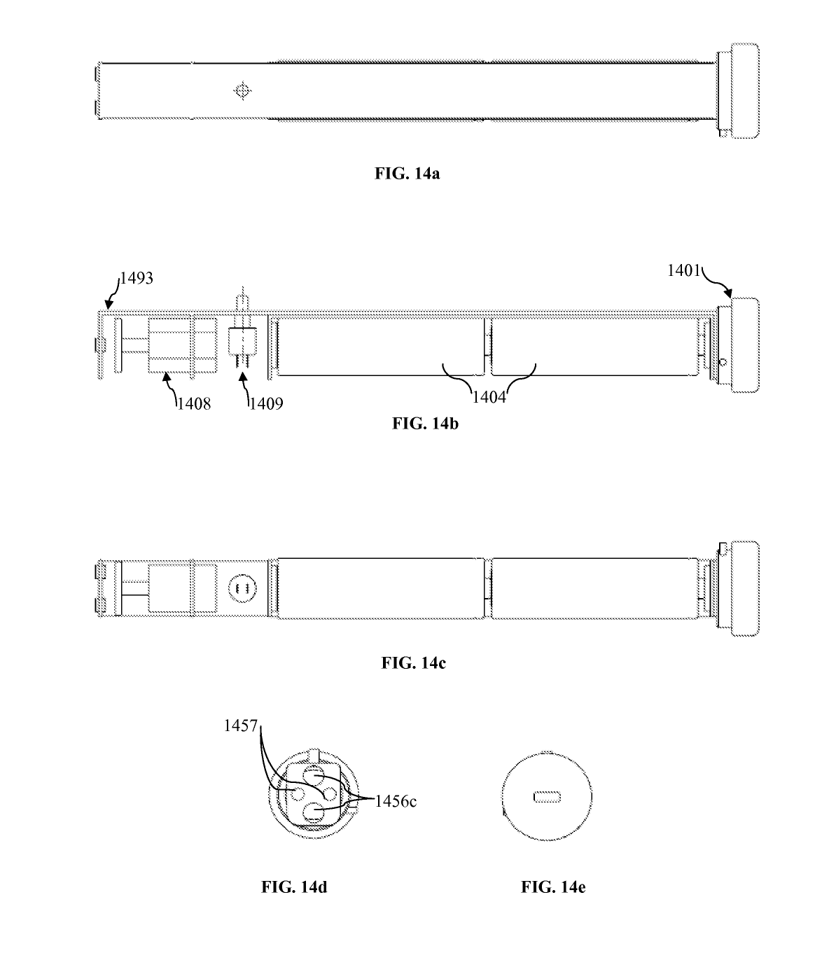

The second major difference is that the cartridge 106 depicted in FIG. 1a (and FIGS. 9a-e) was also eliminated. The bracket mentioned above (1493 in FIG. 14b) not only provides the necessary electrical contacts and contributes to controlling the output current level(s), but is configured to hold in place various components, including the motor and fan assembly 1408 and switch 1409. Hence, there is no longer a need for the cartridge (106, FIG. 1a).

The third major difference is the absence of filter 111 depicted in FIG. 1a. This is because the motor/fan assembly 1108 (FIG. 11d) is configured to work differently here. Air is blown forward through channels 1156a (FIG. 11b) in order to dissipate the fumes surrounding the melting element 1119. Thus, there is no longer a need for the filter. In addition, one major advantage of this configuration is that the blown air prevents the plastic from fusing back together.

These three major changes simplify the manufacturing and assembling process, hence the cost of producing the melting pen. Furthermore, less maintenance issues are likely to surface.

There is also a fourth major difference. The cap 1101 (FIG. 11a and 11d) was modified to allow the coupling of a battery charger, by providing the charger aperture 1188 capable of receiving a corresponding end of the output cord of a standard charger. This change allows the user of the melting pen to use rechargeable batteries (1104) and it affords a convenient way to recharge those batteries.

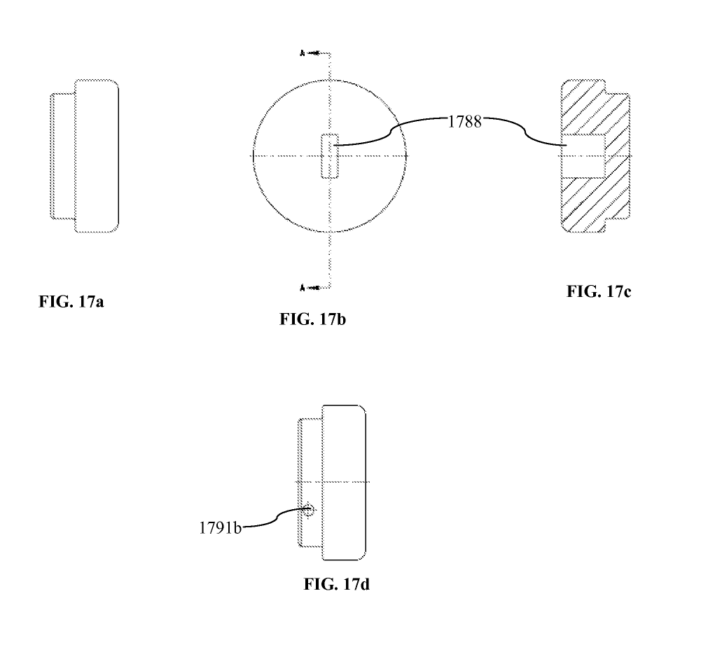

The melting pen 1100 embodies other changes as it will be evident from the following description. The melting pen's head 1120 comprises the heating element 1119, the heating element holder 1115 and spring guard 1116. The head 1120 has a guide pin 1391a (FIGS. 13b and 13d) which fits into the aperture 1166a of housing 1105, thus allowing for a quick connect-disconnect operation by a simple action such as a “push and twist” action. One or more openings 1155 may be made into the housing 1105 to facilitate, by functioning as air inlet(s), the blowing of air forward through the channels 1156a, as explained earlier. A switch cover 1110 may be provided similar with the 110 cover from FIG. 1a. The cap 1101 also has a guide pin 1791b (FIG. 17d), which, in combination with aperture 1166b, facilitates, as explained above, a quick coupling-decoupling of the cap 1101 to and from the housing 1105.

FIG. 11b and FIG. 11e are left and right views, respectively, of the melting pen from FIG. 11a and they show the heating element 1119, the spring guard 1116, the housing 1105, the switch cover 1110, the heating element holder 1115, the channels 1156a, and the charger aperture 1188.

FIG. 11d is a sectional view, along line A-A, of the melting pen from FIG. 11a. FIG. 11d shows the heating element 1119 having a modified “W” or “M” shape, the spring guard 1116 which is conically tapered, heating element holder 1115, contact assembly 1177 between heating element 1119 and bracket (not shown here; 1493 in FIG. 14b), fan/motor assembly 1108, switch 1109, batteries 1104, housing 1105 and cap 1101 with its charger aperture 1188.

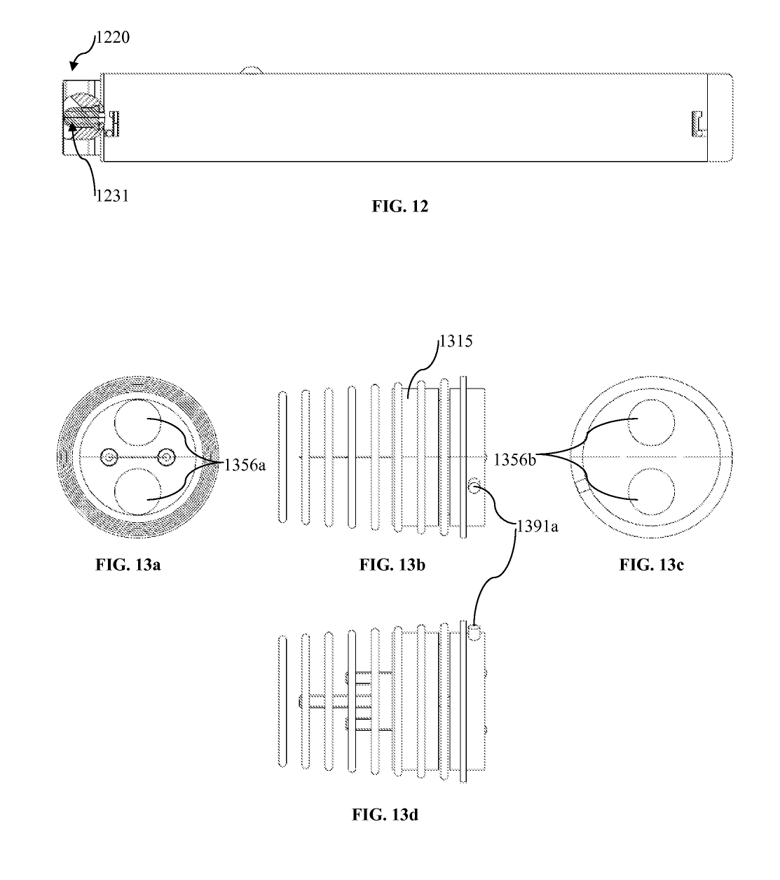

FIG. 12 is a side view of the pen from FIG. 11a, which was adapted to function as a penlight, according to another embodiment. As previously explained, the head 1120 from FIG. 1a may be replaced with a head 1220 comprising a LED 1231, thus making the pen function as a penlight.

FIGS. 13 a-d are various views of the melting pen's head 1120 depicted in FIG. 11a, as follows: FIG. 13a is left view, FIG. 13b is a side view, FIG. 13c is a right view and FIG. 13d is a top view. The openings 1356a are the front, and the openings 1356b are the back, of the channels which pass through the heating element holder 1315. As earlier explained, through these channels, the fan may blow air in order to dissipate the fumes generated by the melting of, for example, plastic, and therefore, to decrease the likelihood that the fumes will be inhaled by the user.

FIGS. 14 a-e are various views of the melting pen's miscellaneous components and bracket 1493 assembly, as follows: FIG. 14a is a top view, FIG. 14b is a side view, FIG. 14c is a bottom view, FIG. 14d is a left view and FIG. 14e is a right view. Again, as earlier described, the bracket 1493 is so configured as to provide the necessary electrical contacts, but has also a mechanical function, that of holding in place miscellaneous components such as the fan/motor assembly 1408, the switch 1409, and the batteries 1404. As shown in FIGS. 14 a-c, the cap 1401 may be permanently attached to the bracket 1493 for a quick and simultaneous coupling with the melting pen's housing (1105 in FIG. 11a). Furthermore, as depicted in FIG. 14d, the front of bracket 1493 comprises two holes 1457 to accommodate the heating element's contacts and two larger holes 1456c to facilitate the air blowing process described earlier.

FIGS. 15 a-d are various views of the bracket 1493 depicted in FIG. 14b, as follows: FIG. 15a is a side view, FIG. 15b is a top view, FIG. 15c is a left view and FIG. 15d is a cross-sectional view along line A-A in FIG. 15a. The opening 1594 may be used to hold in place the fan/motor assembly (1408 in FIG. 14b).

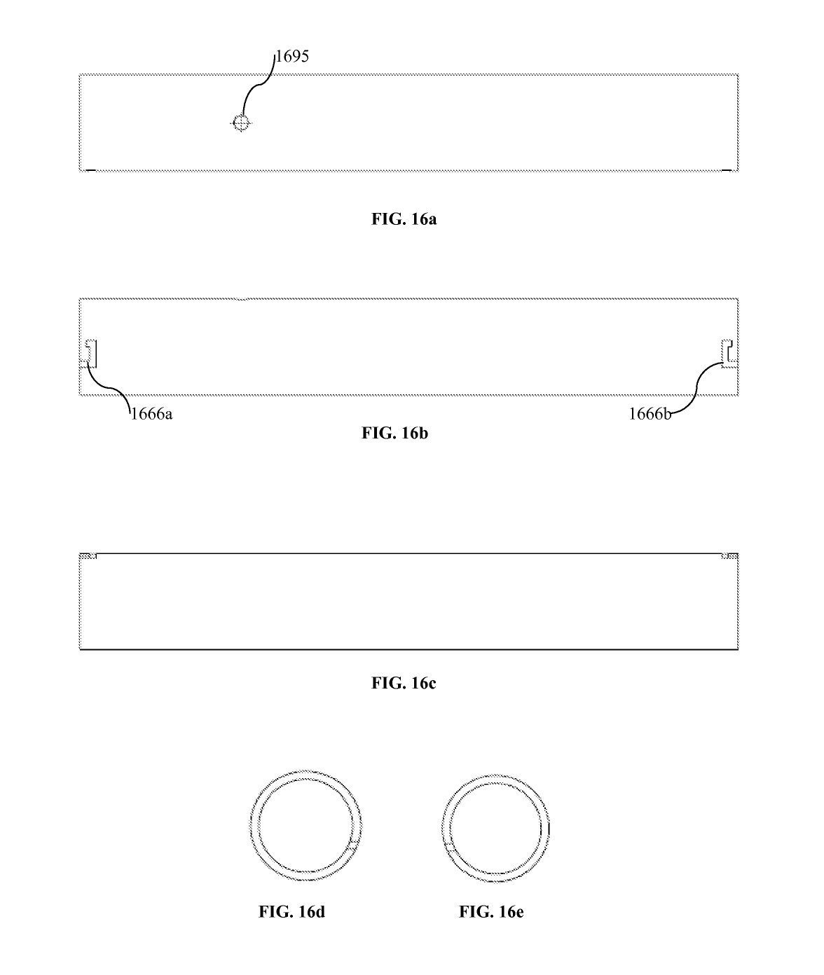

FIGS. 16 a-e illustrate various views of the melting pen's housing 1105, depicted in FIG. 11a, as follows: FIG. 16a is a top view, FIG. 16b is a side view, FIG. 16c is a bottom view, FIG. 16d is a left view and FIG. 16e is a right view. The hole 1695 is sized to accommodate the switch (1109 in FIG. 11d), and the apertures 1666a and 1666b are configured, as explained earlier, to accommodate the guide pins of the head (1391a in FIG. 13b) and cap (1791b in FIG. 17d), respectively.

FIGS. 17 a-d are various views of the melting pen's cap 1101 depicted in FIG. 11a, as follows: FIG. 17a is a back view, FIG. 17b is a right view, FIG. 17c is sectional view taken along line A-A in FIG. 17b, and FIG. 17d is a front view. Again, the charger aperture 1788 is adapted to receive the corresponding end of the output cord of a standard battery charger. While the shape shown here is a rectangular shape, other shapes may be used (e.g., circular) as it may be necessary for proper connection with the standard charger selected to accompany the melting pen.

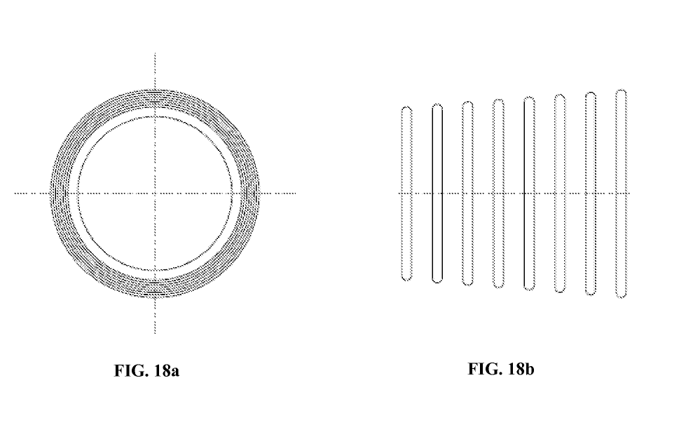

FIG. 18a and FIG. 18b are left and side views, respectively, of the guard spring 1116 depicted in FIG. 11a. It should be noted that the guard spring has a conical taper. This design increases the precision with which the user may use the melting pen. The smaller distal circumference of the spring allows a more exact positioning of the heating element at the desired location.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the present invention. Therefore, the scope of this application is intended to cover alternate embodiments and/or equivalent variations of the specific embodiments illustrated and/or described herein. Hence, the scope of the present invention is defined by the accompanying claims and their equivalents. Furthermore, each and every claim is incorporated as further disclosure into the specification and the claims are embodiment(s) of the present invention.

What is claimed is:

1. A melting pen comprising:
a heating element, which is controllably connected to an independent power source;
means for regulating the current from the power source, which reaches said heating element, so that, said heating element is capable of melting plastic sheets of predetermined thicknesses; and
a protective spring surrounding said heating element.

2. The melting pen of claim 1, wherein said heating element is made of nichrome wire.

3. The melting pen of claim 1, wherein said heating element has a sharpened edge.

4. The melting pen of claim 1, further comprising means for filtering the fumes resulting from melting the plastic sheet.

5. The melting pen of claim 1, further comprising a housing element configured to house said power source and the means for regulating the current.

6. The melting pen of claim 5, further comprising means for preventing heat from said heating element to be transferred to said housing element.

7. A multifunctional tool system comprising:
a housing element, configured to house an independent power source and means for activating said power source; and
a plurality of interchangeable and distinct head elements which are removably associated with said housing element, and wherein, at least one of said head elements comprises a heating element configured to melt predetermined materials.

8. The tool system of claim 7, wherein said heating element is made of nichrome wire.

9. The tool system of claim 7, wherein said heating element has a sharpened edge.

10. The tool system of claim 7, further comprising means for filtering the fumes resulting from melting said materials.

11. The tool system of claim 7, further comprising a protective spring surrounding said heating element.

12. The tool system of claim 7, further comprising means for preventing heat from said heating element to be transferred to said housing element.

13. The tool system of claim 7, wherein at least one of the said head elements is configured to accommodate a cutting blade.

14. The tool system of claim 13, further comprising a protective spring surrounding said blade.

15. The tool system of claim 7, wherein at least one of the said head elements is a flashlight head.

16. A device comprising:
a heating element;
a housing element, configured to house an independent power source, a fan and motor assembly, and means for providing a controllable electrical connection between said independent power source and said heating element and fan and motor assembly;
means for removably connecting said heating element to one end of said housing element; and
a cap, which is removably connected to the other end of said housing element.

17. The device of claim 16, further comprising means for permitting said fan and motor assembly to dissipate the fumes surrounding said heating element when said heating element, while activated, comes in contact with a targeted material, and to prevent separated portions of said material from fusing back together.

18. The device of claim 16, wherein said independent power source comprises rechargeable batteries.

19. The device of claim 18, further comprising means for permitting coupling with a standard charger in order to recharge said rechargeable batteries.

20. The device of claim 16, wherein said heating element has a “W” shape.

21. The device of claim 16, wherein said heating element is surrounded by a spring guard.

22. The device of claim 21, wherein said spring guard is conically tapered.
